(19) United States
(12) Patent Application Publication
(10) Pub. No.: US 2009/0157743 A1
(43) Pub. Date: Jun. 18, 2009

(54) MEDIA FILE GENERATION METHOD AND MEDIA PLAYBACK METHOD

(75) Inventor: Wen-Shun LI, Vancouver (CA)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/954,413

(22) Filed: Dec. 12, 2007

(51) Int. Cl. G06F 17/30

(52) U.S. Cl. 707/104.1; 707/E17.009

(57) ABSTRACT

A media file generation method for use in a device having at least one video source is provided. At least one frame is received from the at least one video source. A media file is generated by recording the received frame and a specific number corresponding to the video source transmitting the frame along a timeline.

### BACKGROUND OF THE INVENTION

1. Field of the Invention

The disclosure relates generally to media file generation methods and media playback methods, and, more particularly to generation and playback methods for 3-coordinate media files.

2. Description of the Related Art

Generally, video is a sequence of frames (images) along a timeline. During video playback, the frames are displayed based on the timeline on display devices such as computer screens. Conventionally, 2-coordinate media files are used for recording media/videos, wherein one coordinate represents the time coordinate and the other is the frame coordinate. The frames may be 2-D images or 3-D graphics. If the frames are 3-D graphics, the video is called a 3-D video. The media file containing the 3-D video, however, is still a 2-coordinate media file since only the time and frame coordinates are provided.

FIG. 1 illustrates a conventional 2-coordinate media file. As shown in FIG. 1, the media file has two coordinates including time and frame. The media file records frames along the timeline. For example, a frame F0 is recorded at time point T0, a frame F1 is recorded at time point T1, a frame F2 is recorded at time point T2, and so on. The media file is input to a display device, and the media file can be therefore played backed by playing back the frames along the timeline.

A keyboard-video-mouse (KVM) switch is a hardware device that allows a user to control multiple hosts such as computers from a keyboard, video monitor and mouse. The KVM switch will pass signals between the hosts and the keyboard, video monitor and mouse. In some cases, each host may be a video source, and the KVM switch receives and records the frames therefrom. Conventionally, the KVM switch records a 2-coordinate media file for each video source. That is, if 8 hosts are coupled with the KVM switch, 8 media files are generated correspondingly, wherein frames of respective video source are captured and recorded to the corresponding media file along the timeline. In some cases, management, such as arrangement or retrieval of the media files, is difficult if too many video sources are coupled with the KVM switch. Additionally, when the video sources are played back, the frames among different video sources may be asynchronous since the frames of respective video sources in corresponding media files are recorded independently.

### BRIEF SUMMARY OF THE INVENTION

Media file generation methods and media playback methods are provided.

In a media file generation method for use in a device having at least one video source, at least one frame is received from the at least one video source. A media file is generated by recording the received frame and a specific number corresponding to the video source transmitting the frame along a timeline.

In a media playback method, a media file recording at least one frame of a video source and a specific number corresponding to the video source along a timeline is obtained. The media file is played back by playing back the frame based on the specific number along the timeline.

In a media file generation method for use in a device having at least one video source, at least one first frame is captured from a first video source, and at least one second is captured frame from a second video source. A media file is generated by recording the first frame and a first specific number corresponding to the first video source, and the second frame and a second specific number corresponding to the second video source along a timeline to the media file.

Media file generation methods and media playback methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 (Prior Art) is a schematic diagram illustrating a conventional 2-coordinate media file;

FIG. 2 is a schematic diagram illustrating an embodiment of a media recorder for generating a 3-coordinate media file according to the invention;

FIG. 3 is a flowchart of an embodiment of a media file generation method according to the invention;

FIG. 4 is a schematic diagram illustrating an example of a 3-coordinate media file in time-sharing mode;

FIG. 5 is a schematic diagram illustrating an example of a 3-coordinate media file in time-overriding mode;

FIG. 6 is a flowchart of an embodiment of a media retrieval method according to the invention; and

FIG. 7 is a flowchart of an embodiment of a media playback method according to the invention.

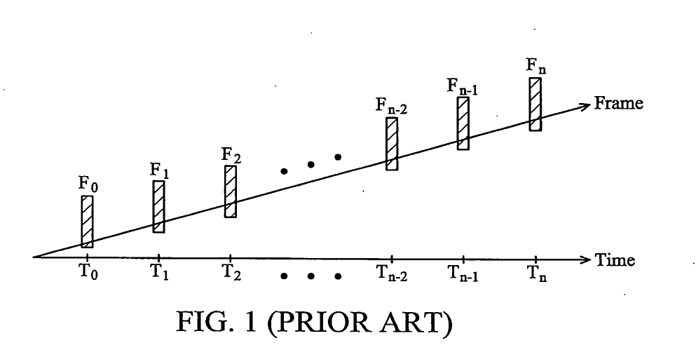

### DETAILED DESCRIPTION OF THE INVENTION

Media file generation methods and media playback methods are provided.

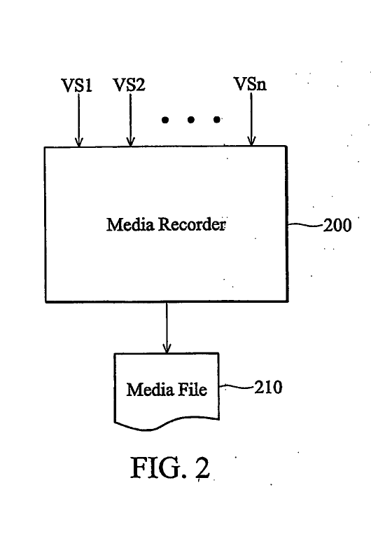

FIG. 2 is a schematic diagram illustrating an embodiment of a media recorder for generating a 3-coordinate media file according to the invention.

As shown in FIG. 2, the media recorder 200 couples to a plurality of video sources VS1, VS2, . . . , and VSn. In some embodiments, the video source may be a channel of a KVM switch, and the respective video sources may correspond to different KVM switches. The media recorder 200 receives frames from the video sources, and generates a 3-coordinate media file 210. Additionally, if operations such as keyboard or mouse operations are performed on the frames on the KVM switches, the operating data corresponding to the operations is also received from the video sources, and recorded to the 3-coordinate media file 210. The format of the 3-coordinate media file 210 is discussed later.

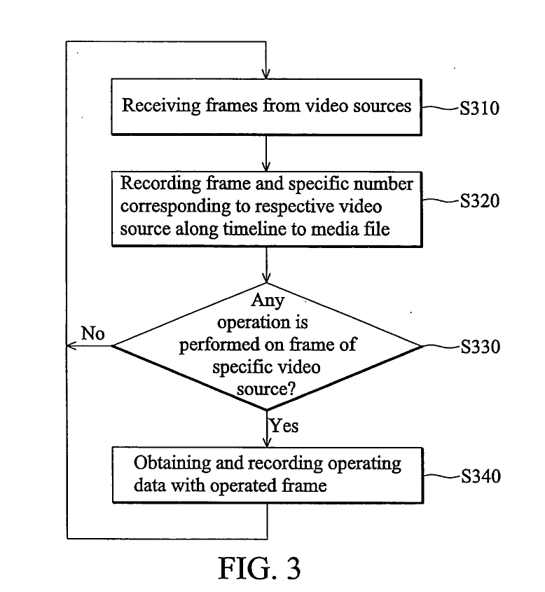

FIG. 3 is a flowchart of an embodiment of a media file generation method according to the invention.

In step S310, frames are received from the respectively video sources. In step S320, the received frame and a specific number corresponding to the video source transmitting the frame are recorded along the timeline to the 3-coordinate media file. In step S330, it is determined whether any operation is performed on any frame of a specific video source. If not (No in step S330), the procedure returns to step S310. If so (Yes in step S330), in step S340, the operating data corresponding to the operation is obtained and recorded with the frame and the specific number corresponding to the video source transmitting the operated frame to the 3-coordinate media file, and the procedure returns to step S310. It is understood that, in some embodiments, if the operating data is directly integrated and transmitted with the frame from the video source, the processes of steps S330 and S340 can be omitted, and the operating data will automatically recorded to the media file with the frame and the specific number corresponding to the video source transmitting the frame.

It is understood that a time-sharing mode and a time-overriding mode are provided to generate a 3-coordinate media file. In the time-sharing mode, frames from respective video sources are captured and recorded to the 3-coordinate media file, simultaneously. For example, a frame is captured from each video source at a time point. In the time-overriding mode, frames of respective video sources are captured in different time points, and respectively recorded to the media file. For example, only one frame is captured from the video sources at a time point.

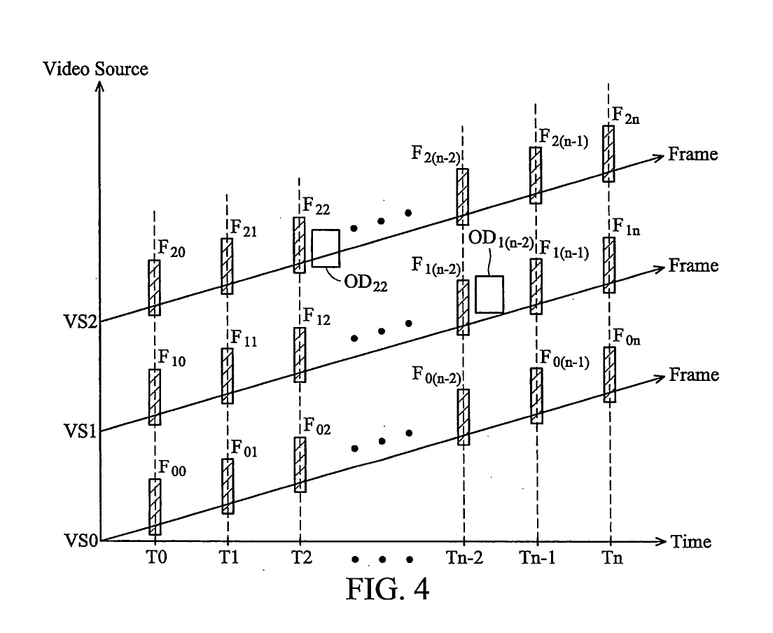

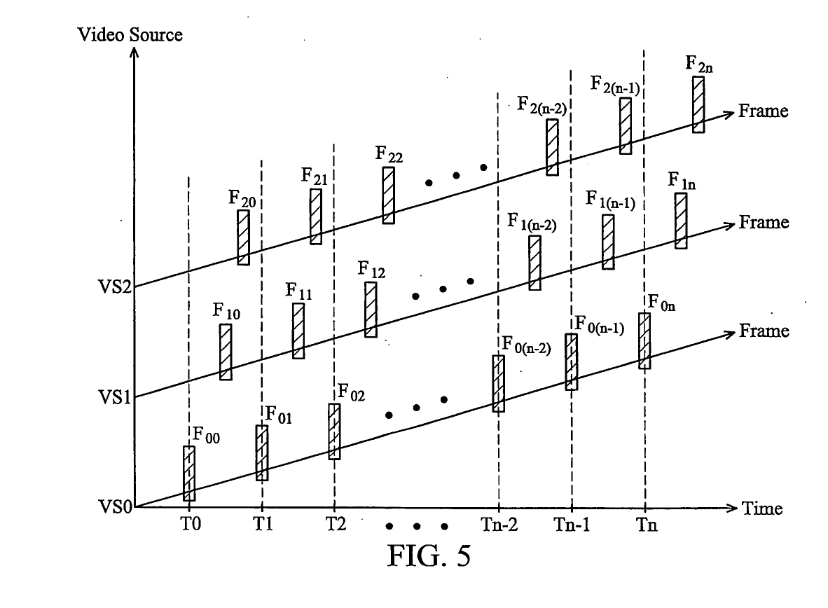

FIG. 4 is a schematic diagram illustrating an example of a 3-coordinate media file in time-sharing mode. As shown in FIG. 4, frames from various video sources are captured and recorded to the 3-coordinate media file, simultaneously, wherein VS0, VS1 and VS2 are specific numbers corresponding to respective video sources. Frames F₀₀, F₁₀ and F₂₀ are captured from video source VS0, VS1 and VS2, respectively, at time point T0, frames F₀₁, F₁₁ and F₂₁ are captured from video source VS0, VS1 and VS2, respectively, at time point T1, and frames F₀₂, F₁₂ and F₂₂ are captured from video source VS0, VS1 and VS2, respectively, at time point T2, and so on. It is noted that at least an operation is performed on frame F₂₂ of video source VS2, the corresponding operating data OD₂₂ is recorded with frame F₂₂ to the 3-coordinate media file. Similarly, at least an operation is performed on frame F₁₍ₙ₋₂₎ of video source VS1, the corresponding operating data OD₁₍ₙ₋₂₎ is recorded with frame F₁₍ₙ₋₂₎ to the 3-coordinate media file. FIG. 5 is a schematic diagram illustrating an example of a 3-coordinate media file in time-overriding mode. As shown in FIG. 5, frames from various video sources are respectively captured at a time point and recorded to the 3-coordinate media file. At a time point, only one frame is captured from one video source. In one embodiment, some video sources are recorded into 3-coordinate media files in time-sharing mode, and some video sources are recorded into 3-coordinate media files in time-overriding mode. For example, video sources VS0 and VS1 are recorded into 3-coordinate media files in time-sharing mode, and video sources VS3 and VS2 are recorded into 3-coordinate media files in time-overriding mode.

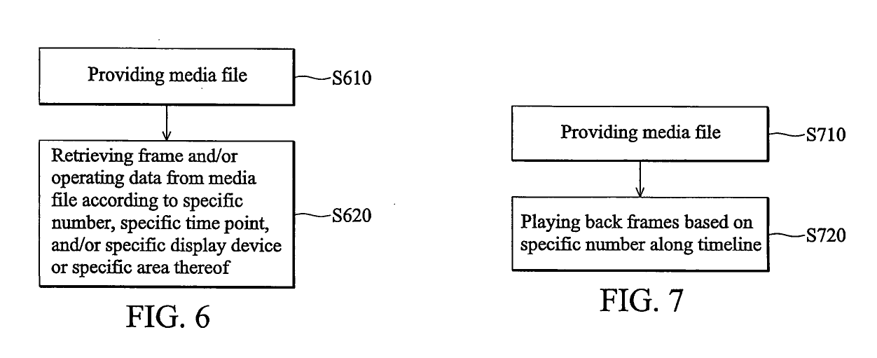

FIG. 6 is a flowchart of an embodiment of a media retrieval method. In this embodiment, the frames and/or operating data in the 3-coordinate media file can be retrieved for management or other applications. In step S610, a 3-coordinate media file is provided. In step S620, the frames and/or operating data in the 3-coordinate media file are retrieved according to a specific number, a specific time point, and/or specific display device or specific display area thereof.

FIG. 7 is a flowchart of an embodiment of a media playback method according to the invention.

In step S710, a 3-coordinate media file is provided to a media playback device for playback. In step S720, the frames in the 3-coordinate media file are played back based on a specific number along the timeline. In some embodiments, a specific number corresponding to a specific video source can be designated, and the frames corresponding to the specific number are retrieved from the 3-coordinate media file, and played back along the timeline. It is understood that the frames corresponding to the specific number are played back on a specific display device corresponding to the specific number, or a specific area (or called virtual device) corresponding to the specific number of a display device. If no specific number is designated, when the 3-coordinate media file is played back, the frames corresponding to all specific numbers (video sources) in the 3-coordinate media file are retrieved, and concurrently played back on corresponding specific display devices or specific areas, respectively, along the timeline. It is also understood that if any operating data is existed with a specific frame, the operation corresponding to the operating data is also performed during the playback of the specific frame. This 3-coordinate media file can be used to save videos from different channels/ports of KVM Switch so that the video can be concurrently replayed in different display devices or different display areas in the same display device (computer screen). The 3-coordinate media file for managing different 2-coordinate media files. It manages different 2-coordinate media files so that they may be concurrently displayed in different display devices or virtual display devices (for example: a display area in the same display device).

Media file generation methods and media playback methods, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A media file generation method for use in a device having at least one video source, comprising:
receiving at least one frame from the at least one video source; and
generating a media file by recording the received frame and a specific number corresponding to the video source transmitting the frame along a timeline.

2. The method of claim 1, wherein when the media file is played back, the frame is played back based on the specific number along the timeline.

3. The method of claim 2, wherein when the media file is played back, the frame is played back on a specific display device corresponding to the specific number along the timeline.

4. The method of claim 2, wherein when the media file is played back, the frame is played back on a specific area corresponding to the specific number of a display device along the timeline.

5. The method of claim 1, further comprising:
obtaining operating data on the frame from the video source; and
recording the operating data with the frame and the specific number corresponding to the video source transmitting the frame along the timeline in the media file.

6. The method of claim 5, wherein the operating data comprises keyboard or mouse operations on at least one KVM switch.

7. The method of claim 5, further comprising retrieving the operating data in the media file according to the specific number, a specific time point on the timeline, or a specific display device or a specific area thereof.

8. The method of claim 1, further comprising retrieving the frame in the media file according to the specific number, a specific time point on the timeline, or a specific display device or a specific area thereof.

9. A media playback method, comprising:
obtaining a media file recording at least one frame of a video source and a specific number corresponding to the video source along a timeline; and
playing back the media file by playing back the frame based on the specific number along the timeline.

10. The method of claim 9, wherein when the media file is played back, the frame is played back on a specific display device corresponding to the specific number along the timeline.

11. The method of claim 9, wherein when the media file is played back, the frame is played back on a specific area corresponding to the specific number of a display device along the timeline.

12. The method of claim 9, wherein the media file further comprises operating data on the frame from the video source.

13. The method of claim 12, wherein the operating data comprises keyboard or mouse operations on at least one KVM switch.

14. The method of claim 12, further comprising retrieving the operating data in the media file according to the specific number, a specific time point on the timeline, or a specific display device or a specific area thereof.

15. The method of claim 9, further comprising retrieving the frame in the media file according to the specific number, a specific time point on the timeline, or a specific display device or a specific area thereof.

16. A media file generation method, comprising:
capturing at least one first frame from a first video source;
capturing at least one second frame from a second video source; and
generating a media file by recording the first frame and a first specific number corresponding to the first video source, and the second frame and a second specific number corresponding to the second video source along a timeline to the media file.

17. The method of claim 16, wherein the first frame and the second frame are captured in different time points on the timeline, and respectively recorded to the media file.

18. The method of claim 16, wherein the first frame and the second frame are captured and recorded to the media file simultaneously.

19. The method of claim 16, wherein when the media file is played back, the first frame is played back on a first specific display device or a first specific area corresponding to the first specific number along the timeline, and the second frame is played back on a second specific display device or a second specific area corresponding to the second specific number along the timeline.

20. The method of claim 16, further comprising retrieving the first frame according to the first specific number, a first specific time point on the timeline, or a first specific display device or a first specific area thereof, and retrieving the second frame according to the second specific number, a second specific time point on the timeline, or a second specific display device or a second specific area thereof.
